(19) United States
(12) Patent Application Publication
(10) Pub. No.: US 2021/0130747 A1
(43) Pub. Date: May 6, 2021

(54) Production Of Perfume-Containing Shaped Bodies

(71) Applicant: Henkel AG & Co. KGaA, Duesseldorf (DE)

(72) Inventors: Mireia Subinya, Massenbachhausen (DE); Ines Baranski, Koeln (DE); Peter Schmiedel, Duesseldorf (DE); Michael Dreja, Neuss (DE); Bernd Larson, Erkelenz (DE); Thomas Holderbaum, Hilden (DE); Dieter Nickel, Pulheim (DE); Regina Stehr, Neuss (DE); Paulina Koehler, Willich (DE)

(21) Appl. No.: 17/147,694

(22) Filed: Jan. 13, 2021

Related U.S. Application Data
(63) Continuation of application No. PCT/EP2019/067121, filed on Jun. 27, 2019.

(30) Foreign Application Priority Data
Jul. 13, 2018 (DE) 102018211691.1

(51) Int. Cl. C11D 3/50; C11D 11/00; C11D 17/06; C11D 3/384; C11D 3/22; C11D 3/00

(52) U.S. Cl. CPC C11D 3/505; C11D 11/0017; C11D 11/0082; C11D 3/001; C11D 3/384; C11D 3/222; C11D 17/06

(57) ABSTRACT

A method for producing dimensionally stable, fragrance-containing shaped bodies based on hydrocolloids. The present invention is also directed to the shaped bodies produced using this method, to the use of these bodies, and to a washing or cleaning agent which contains these bodies.

### FIELD OF THE INVENTION

The present invention relates to a method for producing dimensionally stable, fragrance-containing shaped bodies based on hydrocolloids. The present invention is also directed to the melt bodies produced using this method, to the use of said bodies, and to a washing or cleaning agent which contains said bodies.

### BACKGROUND OF THE INVENTION

When using washing and cleaning agents, the consumer not only aims to wash, clean or care for the objects to be treated, but also wishes that after treatment, for example after washing, the treated objects, such as textiles, have a pleasant smell. For this reason in particular, most commercially available washing and cleaning agents contain fragrances.

The majority of fragrances are, however, volatile. Accordingly, when using conventional washing or cleaning agents, only a small proportion of the fragrance used remains on the treated object after the agent has been used, in particular after washing. As a result, only a weak fragrance emanates from the treated object, such as in particular laundry, which fragrance then gets weaker and weaker after a short period of time. Therefore, the pleasant sensation of freshness of the treated object disappears after just a short period of time.

Fragrances are often used in the form of fragrance pastilles, either as an integral constituent of a washing or cleaning agent, or metered into the washing drum right at the beginning of a wash cycle in a separate form. In this way, the consumer can control the fragrancing of the laundry to be washed by means of individual metering.

Fragrance pastilles of this type are usually produced from melt dispersions, the main constituent of which is a water-soluble or water-dispersible carrier material having a suitable melting temperature. In addition to the fragrance components also contained and optionally other auxiliaries, such as washing-active substances, solids can also be added to melt dispersions of this kind in order to influence the viscosity of the dispersion to be processed, for example. In order to produce the pastilles, there needs to be an uninterrupted supply of such a melt dispersion.

In the prior art, production methods are customary in which a melt consisting of the carrier material and optionally solids and other constituents is first produced and the melt thus obtained is mixed directly with the fragrance component and optionally further constituents, such as dyes. The finished melt dispersion is then shaped into pastilles. However, with such a production method, described for example in the European patent EP 2 496 679 B1, the aforementioned disadvantages are to be expected.

Conventional carrier materials for the fragrance pastilles described in the prior art are inorganic salts or synthetic polymers, polyethylene glycol being of particular importance. From a sustainability point of view, there is need for improvement with respect to the use of high amounts of carrier material, in particular synthetic polymers. There is therefore the need for alternative carrier systems and carrier materials for fragrance pastilles.

Such alternative carrier systems should not only be suitable for the packaging of fragrances such as perfume oils or fragrance capsules, but should also be processable using a variable method which, in addition to uncomplicated process control, offers the possibility of a quick product change (different perfume, different color). During the normal procedure as well as during a product changeover, only the lowest amounts of non-marketable products that are not in line with specifications (waste material) should be generated.

### BRIEF SUMMARY OF THE INVENTION

The above objects were achieved according to the invention by a method during which a hydrocolloid-based preparation is produced in four separate, successive method steps and processed so as to form fragrance pastilles.

In a first aspect, the present invention is therefore directed to a method for producing dimensionally stable, fragrance-containing shaped bodies for textile care, comprising the following steps:
i) producing a flowable preparation comprising water and at least one hydrocolloid;
ii) mixing the preparation from step i) with at least one fragrance so as to form a flowable, fragrance-containing preparation;
iii) portioning the flowable, fragrance-containing preparation from step ii);
iv) forming dimensionally stable, fragrance-containing shaped bodies.

“At least one,” as used herein, refers to one or more, for example 1, 2, 3, 4, 5, 6, 7, 8, 9 or more. In particular, this expression refers to the type of agent/compound and not to the absolute number of molecules. “At least one fragrance” therefore means that at least one type of fragrance is included, but also two or more different types of fragrances may be contained.

“Dimensionally stable,” as used herein, refers to the property of the shaped bodies of maintaining their three-dimensional spatial shape under the conditions that are common in storage and transportation, i.e. that of neither disintegrating nor being irreversibly deformed in the temperature ranges that are common in storage and transportation and under the action of the forces that are common in storage and transportation.

### DETAILED DESCRIPTION OF THE INVENTION

As its first step, the method according to the invention comprises producing a flowable preparation comprising water and at least one hydrocolloid. The proportion by weight of water with respect to the total weight of the dimensionally stable, fragrance-containing shaped body is preferably from 10 to 95 wt. %, particularly preferably from 15 to 90 wt. %, and in particular from 15 to 75 wt. %.

It is preferable to lower the temperature of the flowable preparation provided in step i) during the further method steps. In a preferred embodiment, the flowable preparation in step i) therefore has a temperature above room temperature, preferably between 40 and 100° C.

In addition to water, the flowable preparation provided in step i) of the method contains a hydrocolloid as a second essential constituent.

“Hydrocolloids” (“hydrophilic colloids”) are macromolecules that have a largely linear shape and have intermolecular interaction forces that provide for secondary and main valence bonds between the individual molecules and thus provide for the formation of a net-like structure. They are partially water-soluble, natural or synthetic polymers that form gels or viscous solutions in aqueous systems. They increase the viscosity of the water by either binding water molecules (hydration) or absorbing and enveloping the water in their interconnected macromolecules, while at the same time restricting the mobility of the water.

The synthetic and natural hydrocolloids that are suitable according to the invention include, for example,
organic, fully synthetic compounds, such as polyacrylic and polymethacrylic compounds, vinyl polymers, polycarboxylic acids, polyethers, polyimines and polyamides,
organic, natural compounds, such as agar-agar, carrageenan, tragacanth, gum arabic, alginates, pectins, polyoses, guar flour, locust bean gum, starch, dextrins, gelatin and/or casein,
organic, modified natural substances, such as carboxymethyl cellulose and other cellulose ethers, hydroxyethyl and hydroxypropyl cellulose, etc., and
inorganic compounds, such as polysilicic acids, clay minerals such as montmorillonites, zeolites and silicic acids.

The proportion by weight of the hydrocolloid with respect to the total weight of the dimensionally stable, fragrance-containing shaped bodies is preferably from 0.2 to 25 wt. %, more preferably from 1.0 to 22 wt. %, and in particular from 2.0 to 15 wt. %.

A first group of particularly preferred hydrocolloids is formed by the fully synthetic hydrocolloids, in particular polyacrylic polymers and polymethacrylic polymers, particularly preferably crosslinked polyacrylic acid polymers.

Polyacrylic and polymethacrylic polymers which are advantageous according to the invention should be understood to mean crosslinked or uncrosslinked polyacrylic acid and/or polymethacrylic acid polymers, such as those available from 3V Sigma under the trade names Synthalen K or Synthalen M or from Lubrizol under the trade names Carbopol (for example Carbopol 980, 981, 954, 2984, 5984 and/or Silk 100), each with the INCI name Carbomer. The product marketed by BASF and known by the trade name Cosmedia SP (INCI name: SODIUM POLYACRYLATE) can also be mentioned in this context as a preferred acrylic acid homopolymer.

Copolymers of acrylic acid and/or methacrylic acid can also be used as suitable polyacrylic and polymethacrylic polymers. A suitable polymer in this context is the polymer known by the INCI name Acrylates/C10-30 Alkyl Acrylate Crosspolymer, which is available from Noveon under the trade name Carbopol 1382. A further suitable polymer is the polymer known by the INCI name Acrylates/Steareth-20 Methacrylate Crosspolymer, which is marketed, for example, by Rohm & Haas under the trade name Aculyn® 88. Polymers of the INCI nomenclature Acrylates/Palmeth-25 Acrylate Copolymer or Acrylates/Palmeth-20 Acrylate Copolymer can also be used. Such polymers are available, for example, from 3 V Sigma under the trade name Synthalen® W 2000.

It may also be preferable to use a copolymer of at least one anionic acrylic acid or methacrylic acid monomer and at least one non-ionogenic monomer. Preferred non-ionogenic monomers in this context are acrylamide, methacrylamide, acrylic acid esters, methacrylic acid esters, vinylpyrrolidone, vinyl ethers and vinyl esters.

Further preferred polyacrylic and polymethacrylic polymers are, for example, copolymers of acrylic acid and/or methacrylic acid and the C₁-C₆ alkyl esters thereof, such as those marketed under the INCI name Acrylates Copolymer. One preferred commercial product is Aculyn® 33 from Rohm & Haas, for example. However, copolymers of acrylic acid and/or methacrylic acid, the C₁-C₆ alkyl esters of acrylic acid and/or methacrylic acid and the esters of an ethylenically unsaturated acid and an alkoxylated fatty alcohol are also preferred. Suitable ethylenically unsaturated acids are in particular acrylic acid, methacrylic acid and itaconic acid, and suitable alkoxylated fatty alcohols are in particular Steareth-20 or Ceteth-20. Such copolymers are marketed by Rohm & Haas under the trade name Aculyn® 22 (INCI Name: Acrylates/Steareth-20 Methacrylate Copolymer).

A second group of particularly preferred hydrocolloids is formed by natural hydrocolloids, preferably hydrocolloids from the group of gelatin, agar, gum arabic, guar gum, gellan gum, alginates, carrageenan carraghenates and pectins, particularly preferably from the group of gelatin and agar.

The proportion by weight of the natural hydrocolloid with respect to the total weight of the dimensionally stable, fragrance-containing shaped body is preferably from 0.2 to 25 wt. %, and in particular from 1.0 to 22 wt. %.

With regard to the processability and subsequent formation of the dimensionally stable shaped bodies, it has been found to be advantageous for the flowable preparation in step i) to have a viscosity (50° C., Kinexus Ultra+, 2 cm plate and 800 μm column, shear rate 1/s) of from 10 to 800 Pas, preferably from 20 to 600 Pas. The viscosity of the flowable preparation can be adjusted, for example, by varying the water content, by varying the type and amount of the hydrocolloid, by varying the temperature thereof or by adding the optional rheology modifiers described below.

In step ii) of the method, the previously provided flowable composition is mixed with at least one fragrance.

A fragrance is a chemical substance that stimulates the sense of smell. In order to be able to stimulate the sense of smell, it should be possible to at least partially distribute the chemical substance in the air, i.e. the fragrance should be volatile at 25° C. at least to a small extent. If the fragrance is very volatile, the odor intensity abates quickly. At a lower volatility, however, the smell is more lasting, i.e. it does not disappear as quickly. In one embodiment, the fragrance therefore has a melting point in the range of from −100° C. to 100° C., preferably from −80° C. to 80° C., more preferably from −20° C. to 50° C., in particular from −30° C. to 20° C. In another embodiment, the fragrance has a boiling point in the range of from 25° C. to 400° C., preferably from 50° C. to 380° C., more preferably from 75° C. to 350° C., in particular from 100° C. to 330° C.

Overall, in order to act as a fragrance, a chemical substance should not exceed a certain molecular mass since, if the molecular mass is too high, the required volatility can no longer be ensured. In one embodiment, the fragrance has a molecular mass of from 40 to 700 g/mol, more preferably from 60 to 400 g/mol.

The odor of a fragrance is perceived by most people as pleasant and often corresponds to the smell of, for example, flowers, fruits, spices, bark, resin, leaves, grasses, mosses and roots. Fragrances can thus also be used to overlay unpleasant odors or even to provide a non-smelling substance with a desired odor. It is possible, for example, to use individual odorant compounds, such as synthetic products of the ester, ether, aldehyde, ketone, alcohol and hydrocarbon types, as fragrances.

Fragrance compounds of the aldehyde type are, for example, adoxal (2,6,10-trimethyl-9-undecenal), anisaldehyde(4-methoxybenzaldehyde), cymene(3-(4-isopropyl-phenyl)-2-methylpropanal), ethylvanillin, Florhydral (3-(3-isopropylphenyl)butanal), Helional (3-(3,4-methylenedioxyphenyl)-2-methylpropanal), heliotropin, hydroxycitronellal, lauraldehyde, Lyral (3- and 4-(4-hydroxy-4-methylpentyl)-3-cyclohexene-1-carboxaldehyde), methylnonylacetaldehyde, Lilial (3-(4-tert-butylphenyl)-2-methylpropanal), phenylacetaldehyde, undecylenealdehyde, vanillin, 2,6,10-trimethyl-9-undecenal, 3-dodecen-1-al, alpha-n-amylcinnamaldehyde, melonal (2,6-dimethyl-5-heptenal), 2,4-di-methyl-3-cyclohexene-1-carboxaldehyde (Triplal), 4-methoxybenzaldehyde, benzaldehyde, 3-(4-tert-butylphenyl)-propanal, 2-methyl-3-(para-methoxyphenyl)propanal, 2-methyl-4-(2,6,6-timethyl-2(1)-cyclohexen-1-yl)butanal, 3-phenyl-2-propenal, cis-/trans-3,7-dimethyl-2,6-octadien-1-al, 3,7-dimethyl-6-octen-1-al, [(3,7-dimethyl-6-octenyl)oxy]acetaldehyde, 4-isopropylbenzylaldehyde, 1,2,3,4,5,6,7,8-octahydro-8,8-dimethyl-2-naphthaldehyde, 2,4-dimethyl-3-cyclohexene-1-carboxaldehyde, 2-methyl-3-(isopropylphenyl)propanal, 1-decanal, 2,6-dimethyl-5-heptenal, 4-(tricyclo[5.2.1.0(2,6)]-decylidene-8)-butanal, octahydro-4,7-methane-1H-indenecarboxaldehyde, 3-ethoxy-4-hydroxybenzaldehyde, para-ethyl-alpha, alpha-dimethylhydrocinnamaldehyde, alpha-methyl-3,4-(methylenedioxy)-hydrocinnamaldehyde, 3,4-methylenedioxybenzaldehyde, alpha-n-hexylcinnamaldehyde, m-cymene-7-carboxaldehyde, alpha-methylphenylacetaldehyde, 7-hydroxy-3,7-dimethyloctanal, undecenal, 2,4,6-trimethyl-3-cyclohexene-1-carboxaldehyde, 4-(3)(4-methyl-3-pentenyl)-3-cyclohexene carboxaldehyde, 1-dodecanal, 2,4-dimethylcyclohexene-3-carboxaldehyde, 4-(4-hydroxy-4-methylpentyl)-3-cyclohexene-1-carboxaldehyde, 7-methoxy-3,7-dimethyloctan-1-al, 2-methyl-undecanal, 2-methyldecanal, 1-nonanal, 1-octanal, 2,6,10-trimethyl-5,9-undecadienal, 2-methyl-3-(4-tert-butyl)propanal, dihydrocinnamaldehyde, 1-methyl-4-(4-methyl-3-pentenyl)-3-cyclohexene-1-carboxaldehyde, 5- or 6-methoxyhexahydro-4,7-methanindan-1- or 2-carboxaldehyde, 3,7-dimethyloctan-1-al, 1-undecanal, 10-undecen-1-al, 4-hydroxy-3-methoxybenzaldehyde, 1-methyl-3-(4-methylpentyl)-3-cyclohexenecarboxaldehyde, 7-hydroxy-3J-dimethyl-octanal, trans-4-decenal, 2,6-nonadienal, para-tolylacetaldehyde, 4-methylphenylacetaldehyde, 2-methyl-4-(2,6,6-trimethyl-1-cyclohexen-1-yl)-2-butenal, ortho-methoxycinnamaldehyde, 3,5,6-trimethyl-3-cyclohexene-carboxaldehyde, 3J-dimethyl-2-methylene-6-octenal, phenoxyacetaldehyde, 5,9-dimethyl-4,8-decadienal, peonyaldehyde (6,10-dimethyl-3-oxa-5,9-undecadien-1-al), hexahydro-4,7-methanindan-1-carboxaldehyde, 2-methyloctanal, alpha-methyl-4-(1-methylethyl)benzeneacetaldehyde, 6,6-dimethyl-2-norpinene-2-propionaldehyde, para-methylphenoxyacetaldehyde, 2-methyl-3-phenyl-2-propen-1-al, 3,5,5-trimethylhexanal, hexahydro-8,8-dimethyl-2-naphthaldehyde, 3-propyl-bicyclo-[2.2.1]-hept-5-ene-2-carbaldehyde, 9-decenal, 3-methyl-5-phenyl-1-pentanal, methylnonylacetaldehyde, hexanal and trans-2-hexenal.

Fragrance compounds of the ketone type are, for example, methyl-beta-naphthyl ketone, musk indanone (1,2,3,5,6,7-hexahydro-1,1,2,3,3-pentamethyl-4H-inden-4-one), tonalide (6-acetyl-1,1,2,4,4,7-hexamethyltetralin), alpha-damascone, beta-damascone, delta-damascone, iso-damascone, damascenone, methyldihydrojasmonate, menthone, carvone, camphor, Koavone (3,4,5,6,6-pentamethylhept-3-en-2-one), fenchone, alpha-ionone, beta-ionone, gamma-methyl-ionone, fleuramone (2-heptylcyclopentanone), dihydrojasmone, cis-jasmone, Iso-E-Super (1-(1,2,3,4,5,6J,8-octahydro-2,3,8,8-tetramethyl-2-naphthalenyl)-ethan-1-one (and isomers)), methyl cedrenyl ketone, acetophenone, methyl acetophenone, para-methoxy acetophenone, methyl beta-naphthyl ketone, benzyl acetone, benzophenone, para-hydroxyphenyl butanone, celery ketone (3-methyl-5-propyl-2-cyclohexenone), 6-isopropyldecahydro-2-naphthone, dimethyloctenone, frescomenthe (2-butan-2-yl-cyclohexan-1-one), 4-(1-ethoxyvinyl)-3,3,5,5-tetramethylcyclohexanone, methylheptenone, 2-(2-(4-methyl-3-cyclohexen-1-yl)propyl)cyclopentanone, 1-(p-menthen-6(2)-yl)-1-propanone, 4-(4-hydroxy-3-methoxyphenyl)-2-butanone, 2-acetyl-3,3-dimethylnorbornane, 6,7-dihydro-1,1,2,3,3-pentamethyl-4(5H)-indanone, 4-damascol, Dulcinyl (4-(1,3-benzodioxol-5-yl)butan-2-one), Hexalone (1-(2,6,6-trimethyl-2-cyclohexen-1-yl)-1,6-heptadien-3-one), IsocyclemoneE(2-acetonaphthone-1,2,3,4,5,6,7,8-octahydro-2,3,8,8-tetramethyl), methyl nonylketone, methylcyclocitrone, methyl lavender ketone, Orivone (4-tert-amyl-cyclohexanone), 4-tert-butylcyclohexanone, Delphone (2-pentyl-cyclopentanone), muscone (CAS 541-91-3), Neobutenone (1-(5,5-dimethyl-1-cyclohexenyl)pent-4-en-1-one), plicatone (CAS 41724-19-0), Veloutone (2,2,5-trimethyl-5-pentylcyclopentan-1-one), 2,4,4,7-tetramethyl-oct-6-en-3-one and tetramerane (6,10-dimethylundecen-2-one).

Fragrance compounds of the alcohol type are, for example, 10-undecen-1-ol, 2,6-dimethylheptan-2-ol, 2-methylbutanol, 2-methylpentanol, 2-phenoxyethanol, 2-phenylpropanol, 2-tert-butycyclohexanol, 3,5,5-trimethylcyclohexanol, 3-hexanol, 3-methyl-5-phenylpentanol, 3-octanol, 3-phenyl-propanol, 4-heptenol, 4-isopropylcyclohexanol, 4-tert-butycyclohexanol, 6,8-dimethyl-2-nonanol, 6-nonen-1-ol, 9-decen-1-ol, α-methylbenzyl alcohol, α-terpineol, amyl salicylate, benzyl alcohol, benzyl salicylate, 0-terpineol, butyl salicylate, citronellol, cyclohexyl salicylate, decanol, dihydromyrcenol, dimethyl benzyl carbinol, dimethyl heptanol, dimethyl octanol, ethyl salicylate, ethyl vanillin, eugenol, farnesol, geraniol, heptanol, hexyl salicylate, isoborneol, isoeugenol, isopulegol, linalool, menthol, myrtenol, n-hexanol, nerol, nonanol, octanol, p-menthan-7-ol, phenylethyl alcohol, phenol, phenyl salicylate, tetrahydrogeraniol, tetrahydrolinalool, thymol, trans-2-cis-6-nonadicnol, trans-2-nonen-1-ol, trans-2-octenol, undecanol, vanillin, champiniol, hexenol and cinnamyl alcohol.

Fragrance compounds of the ester type are, for example, benzyl acetate, phenoxyethyl isobutyrate, p-tert-butylcyclohexyl acetate, linalyl acetate, dimethylbenzylcarbinyl acetate (DMBCA), phenylethyl acetate, benzyl acetate, ethylmethylphenyl glycinate, allylcyclohexyl propionate, styrallyl propionate, benzyl salicylate, cyclohexyl salicylate, floramate, melusate, and jasmacyclate.

Ethers include, for example, benzyl ethyl ether and Ambroxan. Hydrocarbons mainly include terpenes such as limonene and pinene.

Preferably, mixtures of different fragrances are used, which together produce an appealing fragrance note. Such a mixture of fragrances may also be referred to as perfume or perfume oil. Perfume oils of this kind may also contain natural fragrance mixtures, such as those obtainable from plant sources.

Fragrances of plant origin include essential oils such as angelica root oil, aniseed oil, arnica blossom oil, basil oil, bay oil, champaca blossom oil, citrus oil, abies alba oil, abies alba cone oil, elemi oil, eucalyptus oil, fennel oil, pine needle oil, galbanum oil, geranium oil, ginger grass oil, guaiac wood oil, gurjun balsam oil, helichrysum oil, ho oil, ginger oil, iris oil, jasmine oil, cajeput oil, calamus oil, chamomile oil, camphor oil, cananga oil, cardamom oil, cassia oil, pine needle oil, copaiba balsam oil, coriander oil, spearmint oil, caraway oil, cumin oil, labdanum oil, lavender oil, lemon grass oil, lime blossom oil, lime oil, mandarin oil, melissa oil, mint oil, musk seed oil, muscatel oil, myrrh oil, clove oil, neroli oil, niaouli oil, olibanum oil, orange blossom oil, orange peel oil, oregano oil, palmarosa oil, patchouli oil, balsam Peru oil, petitgrain oil, pepper oil, peppermint oil, allspice oil, pine oil, rose oil, rosemary oil, sage oil, sandalwood oil, celery oil, spike lavender oil, star anise oil, turpentine oil, thuja oil, thyme oil, verbena oil, vetiver oil, juniper berry oil, wormwood oil, wintergreen oil, ylang-ylang oil, hyssop oil, cinnamon oil, cinnamon leaf oil, citronella oil, lemon oil and cypress oil, and ambrettolide, Ambroxan, alpha-amylcinnamaldehyde, anethole, anisaldehyde, anise alcohol, anisole, anthranilic acid methyl ester, acetophenone, benzylacetone, benzaldehyde, benzoic acid ethyl ester, benzophenone, benzyl alcohol, benzyl acetate, benzyl benzoate, benzyl formate, benzyl valerianate, borneol, bornyl acetate, boisambrene forte, alpha-bromostyrene, n-decylaldehyde, n-dodecyl aldehyde, eugenol, eugenol methyl ether, eucalyptol, farnesol, fenchone, fenchyl acetate, geranyl acetate, geranyl formate, heliotropin, heptyne carboxylic acid methyl ester, heptaldehyde, hydroquinone dimethyl ether, hydroxycinnamaldehyde, hydroxycinnamyl alcohol, indole, irone, isoeugenol, isoeugenol methyl ether, isosafrole, jasmine, camphor, carvacrol, carvone, p-cresol methyl ether, coumarin, p-methoxyacetophenone, methyl n-amyl ketone, methylanthranilic acid methyl ester, p-methylacetophenone, methyl chavicol, p-methylquinoline, methyl beta-naphthyl ketone, methyl n-nonyl acetaldehyde, methyl n-nonyl ketone, muscone, beta-naphthol ethyl ether, beta-naphthol methyl ether, nerol, n-nonylaldehyde, nonyl alcohol, n-octylaldehyde, p-oxy-acetophenone, pentadecanolide, beta-phenethyl alcohol, phenylacetic acid, pulegone, safrole, salicylic acid isoamyl ester, salicylic acid methyl ester, salicylic acid hexyl ester, salicylic acid cyclohexyl ester, santalol, skatole, terpineol, thymene, thymol, troenan, gamma-undecalactone, vanillin, veratraldehyde, cinnamaldehyde, cinnamyl alcohol, cinnamic acid, cinnamic acid ethyl ester, cinnamic acid benzyl ester, diphenyl oxide, limonene, linalool, linalyl acetate and propionate, melusate, menthol, menthone, methyl-n-heptenone, pinene, phenylacetaldehyde, terpinyl acetate, citral, citronellal and mixtures thereof.

In one embodiment, it may be preferable for at least some of the fragrance to be used as a fragrance precursor or in encapsulated form (fragrance capsules), in particular in microcapsules. However, it is also possible to use the entire fragrance in encapsulated or non-encapsulated form. The microcapsules may be water-soluble and/or water-insoluble microcapsules. For example, melamine-urea-formaldehyde microcapsules, melamine-formaldehyde microcapsules, urea-formaldehyde microcapsules or starch microcapsules can be used. “Fragrance precursor” refers to compounds that release the actual fragrance only after chemical conversion/cleavage, typically by exposure to light or other environmental conditions such as pH, temperature, etc. Such compounds are often also referred to as fragrance storage substances or “pro-fragrances.”

For the later effect of the shaped bodies, it has been found to be advantageous if the fragrance in step ii) is selected from the group of perfume oils and fragrance capsules. The use of a combination of perfume oil and fragrance capsules is very particularly preferred.

Irrespective of the form in which they are used, the proportion by weight of the fragrance with respect to the total weight of the dimensionally stable, fragrance-containing shaped body is preferably from 1 to 20 wt. %, more preferably from 1 to 15 wt. %, and in particular from 3 to 10 wt. %. As a result of the method according to the invention, the fragrance, for example the perfume oil or the fragrance capsules, is homogeneously distributed in the dimensionally stable shaped body.

In addition to the ingredients described above, namely water, hydrocolloid and fragrance, other active substances or auxiliaries can be added to the flowable composition. These further active substances or auxiliaries can be incorporated in step i), in step ii), between steps i) and ii), or between steps ii) and iii).

The preferred further active substances or auxiliaries include water-miscible organic solvents. In a preferred method variant, these solvents are added to the flowable fragrance-containing preparation before step iii) of the method.

Particularly preferred methods are characterized in that at least one water-miscible organic solvent, preferably at least one solvent from the group of ethanol, n-propanol, propanol, butanols, glycol, propanediol, butanediol, methylpropanediol, glycerol, propylene carbonate, diglycol, propyl diglycol, butyl diglycol, hexylene glycol, diethylene glycol ethyl ether, diethylene glycol methyl ether, diethylene glycol-n-butyl ether, diethylene glycol hexyl ether, diethylene glycol-n-butyl ether acetate, ethylene glycol propyl ether, ethylene glycol-n-butyl ether, ethylene glycol hexyl ether, ethylene glycol-n-butyl ether acetate, triethylene glycol, triethylene glycol methyl ether, triethylene glycol ethyl ether, triethylene glycol-n-butyl ether, ethylene glycol phenyl ether, propylene glycol methyl ether, dipropylene glycol methyl ether, tripropylene glycol methyl ether, propylene glycol methyl ether acetate, dipropylene glycol methyl ether acetate, propylene glycol-n-propyl ether, dipropylene glycol-n-propyl ether, propylene glycol-n-butyl ether, dipropylene glycol-n-butyl ether, tripropylene glycol-n-butyl ether, propylene glycol phenyl ether, propylene glycol diacetate, dipropylene glycol dimethyl ether, methoxytriglycol, ethoxytriglycol, butoxytriglycol, 1-butoxyethoxy-2-propanol, 3-methyl-3-methoxybutanol, propylene-glycol-t-butyl ether and di-n-octylether, more preferably from the group of glycerol, propylene glycol and triethylene glycol, in particular glycerol, is also added to the flowable, fragrance-containing preparation before step iii).

The proportion by weight of the water-miscible organic solvent with respect to the total weight of the dimensionally stable, fragrance-containing shaped body is preferably from 1.0 to 30 wt. %, more preferably from 2.0 to 25 wt. %, and in particular from 10 to 20 wt. %.

In order to influence the flow and deformation behavior, at least one rheology modifier from the group of microfibrillated or microcrystalline celluloses is preferably added to the flowable, fragrance-containing composition before step iii). Microfibrillated or microcrystalline cellulose is commercially available, for example, as Exilva (Borregaard) or Avicel® (FMC). The proportion by weight of the rheology modifier with respect to the total weight of the dimensionally stable, fragrance-containing shaped bodies is preferably from 0.5 to 20 wt. %, more preferably from 1.0 to 18 wt. %, and in particular from 2.0 to 15 wt. %.

Another group of preferred optional active substances and auxiliaries is formed by disintegration auxiliaries, which are naturally not the same as the hydrocolloids described above. These disintegration auxiliaries are also added to the flowable, fragrance-containing composition preferably before step iii).

Preferred methods are characterized in that at least one disintegration auxiliary that is different from the hydrocolloid and comes from the group of synthetic polymers, preferably from the group of polyacrylates and polyvinylpyrrolidones, in particular crosslinked polyvinylpyrrolidones, is also added to the flowable, fragrance-containing composition before step iii).

Disintegration auxiliaries are preferably used in amounts of from 0.05 to 5 wt. %, particularly preferably from 0.1 to 3 wt. %, more preferably from 0.2 to 2 wt. %, in each case based on the total weight of the dimensionally stable, fragrance-containing shaped body.

Further optional active substances and auxiliaries are non-ionic surfactants, the addition of which improves the processability of the flowable, fragrance-containing composition. For this reason, methods are preferred in which at least one non-ionic surfactant, preferably a non-ionic surfactant from the group of polyalkoxylated sorbitan acid esters, is also added to the flowable, fragrance-containing composition before step iii). The proportion by weight of the non-ionic surfactant with respect to the total weight of the dimensionally stable, fragrance-containing shaped body is preferably from 0.05 to 3.0 wt. %, particularly preferably from 0.1 to 2.0 wt. %.

In addition or as an alternative to the above-mentioned active substances and auxiliaries, preferred dimensionally stable, fragrance-containing shaped bodies contain at least one solid from the group consisting of polysaccharides, silicic acids, silicates, sulfates, phosphates, halides and carbonates. By adding these solids, the processability of the flowable, fragrance-containing composition can also be improved. Methods during which at least one solid from the group consisting of polysaccharides, silicic acids, silicates, sulfates, phosphates, halides and carbonates is also added to the flowable, fragrance-containing composition before step iii) are preferred.

In order to improve the aesthetic impression of the shaped bodies, at least one dye is preferably added to the flowable, fragrance-containing composition during the method. It is preferable for at least one dye, preferably at least one water-soluble dye, particularly preferably a water-soluble polymer dye, to be added to the flowable, fragrance-containing composition before step iii).

As already explained, a melt body composition produced according to the invention may contain at least one dye in order to improve the aesthetic impression of the melt body composition. Preferred dyes, which can be selected by a person skilled in the art without any difficulty at all, should be highly stable in storage, unaffected by the other ingredients of the washing or cleaning agent, insensitive to light and should not exhibit pronounced substantivity with respect to textile fibers in order to avoid dyeing said fibers.

The dye is a conventional dye which can be used for various washing or cleaning agents. The dye is preferably selected from Acid Red 18 (CI 16255), Acid Red 26, Acid Red 27, Acid Red 33, Acid Red 51, Acid Red 87, Acid Red 88, Acid Red 92, Acid Red 95, Acid Red 249 (CI 18134), Acid Red 52 (CI 45100), Acid Violet 126, Acid Violet 48, Acid Violet 54, Acid Yellow 1, Acid Yellow 3 (CI 47005), Acid Yellow 11, Acid Yellow 23 (CI 19140), Acid Yellow 3, Direct Blue 199 (CI 74190), Direct Yellow 28 (CI 19555), Food Blue 2 (CI 42090), Food Blue 5:2 (CI 42051:2), Food Red 7(01 16255), Food Yellow 13 (CI 47005), Food Yellow 3 (CI 15985), Food Yellow 4 (CI 19140), Reactive Green 12 and Solvent Green 7 (CI 59040).

Particularly preferred dyes are water-soluble acid dyes, for example Food Yellow 13 (Acid Yellow 3, CI 47005), Food Yellow 4 (Acid Yellow 23, CI 19140), Food Red 7 (Acid Red 18, CI 16255), Food Blue 2 (Acid Blue 9, CI 42090), Food Blue 5 (Acid Blue 3, CI 42051), Acid Red 249 (CI 18134), Acid Red 52 (CI 45100), Acid Violet 126, Acid Violet 48, Acid Blue 80(01 61585), Acid Blue 182, Acid Blue 182, Acid Green 25 (CI 61570) and Acid Green 81.

Water-soluble direct dyes, for example Direct Yellow 28 (CI 19555) and Direct Blue 199 (CI 74190), and water-soluble reactive dyes, for example Reactive Green 12, and the dyes Food Yellow 3 (CI 15985) and Acid Yellow 184, are equally preferably used.

Aqueous dispersions of the following pigment dyes are equally preferably used: Pigment Black 7 (CI 77266), Pigment Blue 15 (CI 74160), Pigment Blue 15:1 (CI 74160), Pigment Blue 15:3 (CI 74160), Pigment Green 7 (CI 74260), Pigment Orange 5, Pigment Red 112 (CI 12370), Pigment Red 112 (CI 12370), Pigment Red 122 (CI 73915), Pigment Red 179 (CI 71130), Pigment Red 184 (CI 12487), Pigment Red 188 (CI 12467), Pigment Red 4 (CI 12085), Pigment Red 5 (CI 12490), Pigment Red 9, Pigment Violet 23 (CI 51319), Pigment Yellow 1 (CI 28 11680), Pigment Yellow 13 (CI 21100), Pigment Yellow 154, Pigment Yellow 3 (CI 11710), Pigment Yellow 74, Pigment Yellow 83 (CI 21108) and Pigment Yellow 97. In preferred embodiments, the following pigment dyes are used in the form of dispersions: Pigment Yellow 1 (CI 11680), Pigment Yellow 3 (CI 11710), Pigment Red 112 (CI 12370), Pigment Red 5 (CI 12490), Pigment Red 181 (CI 73360), Pigment Violet 23 (CI 51319), Pigment Blue 15:1 (CI 74160), Pigment Green 7 (CI 74260) and Pigment Black 7 (CI 77266).

In equally preferred embodiments, water-soluble polymer dyes are used, for example Liquitint, Liquitint Blue HP, Liquitint Blue MC, Liquitint Blue 65, Liquitint Cyan 15, Liquitint Patent Blue, Liquitint Violet 129, Liquitint Royal Blue, Liquitint Experimental Yellow 8949-43, Liquitint Green HMC, Liquitint Yellow LP, Liquitint Yellow II and mixtures thereof.

The group of very particularly preferred dyes includes Acid Blue 3, Acid Yellow 23, Acid Red 33, Acid Violet 126, Liquitint Yellow LP, Liquitint Cyan 15, Liquitint Blue HP and Liquitint Blue MC.

The proportion by weight of the dye with respect to the total weight of the dimensionally stable, fragrance-containing shaped body is preferably from 0.001 to 0.5 wt. %, more preferably from 0.002 to 0.2 wt. %.

A method according to one of the preceding points, characterized in that at least one preservative is also added to the flowable, fragrance-containing composition before step iii).

Another group of preferred active substances and auxiliaries is formed by bitterns. The addition of bitterns primarily serves to prevent oral ingestion of the fragrance-containing shaped bodies.

Preferred shaped bodies contain at least one bittern in an amount of from 0.0001 to 0.1 wt. %, based on the total weight of the composition. Amounts of from 0.0005 to 0.02 wt. % are particularly preferred. According to the present invention, bitterns which are soluble in water at 20° C. to at least 5 g/l are particularly preferred. With regard to an undesired interaction with the fragrance components also contained in the composition, in particular a change in the fragrance note perceived by the consumer, the ionogenic bitterns have been found to be superior to the non-ionogenic bitterns. Ionogenic bitterns consisting of organic cation(s) and organic anion(s) are consequently preferred for the composition according to the invention.

In various embodiments, the at least one bittern is therefore an ionogenic bittern.

Quaternary ammonium compounds which contain an aromatic group both in the cation and in the anion are exceptionally suitable in the context of the present invention. In various embodiments, the at least one bittern is therefore a quaternary ammonium compound.

A suitable quaternary ammonium compound is, for example, without limitation, benzyldiethyl((2,6-xylylcarbamoyl)methyl)ammonium benzoate, which is commercially available under the trademarks Bitrex® and Indigestin®, for example. This compound is also known by the name denatonium benzoate. In various embodiments, the at least one bittern is benzyldiethyl((2,6-xylylcarbamoyl)methyl) ammonium benzoate (Bitrex®). If Bitrex® is used, amounts of up to 0.002 wt. % are most preferred. The amounts are in each case based on the active substance content.

Methods during which at least one bittern is also added to the flowable, fragrance-containing composition or the dimensionally stable, fragrance-containing shaped body are preferred.

The bittern can be incorporated, for example, by adding an appropriate compound to the flowable, fragrance-containing composition. In an alternative and preferred method variant, the bittern is applied to the surface of the portioned preparation after step iii) of the method. It is particularly preferable to spray the bittern onto the surface of the portioned preparation after step iii), in particular onto the surface of the dimensionally stable, fragrance-containing shaped body.

The portioning and shaping of the flowable, fragrance-containing preparation obtained in step ii) can be achieved using conventional shaping methods. Suitable shaping methods are known to a person skilled in the art. Examples include pastillation, dropwise application or extrusion.

In a preferred method variant, the flowable, fragrance-containing composition is portioned in step iii) by being applied to a surface in a dropwise manner. Drop formers comprising a rotating, perforated outer drum are particularly suitable for applying the composition in a dropwise manner in step iii). Methods in which the flowable, fragrance-containing composition is portioned in step iii) by being applied to a steel belt in a dropwise manner by means of a drop former comprising a rotating, perforated outer drum are preferred because of the product aesthetics achieved. The distance between the outer face of the rotating, perforated outer drum and the surface of the steel belt is preferably between 5 and 20 mm.

The solidification of the preparation applied in a dropwise manner is preferably facilitated and accelerated by cooling. The drops applied to the surface, preferably the steel belt, can be cooled directly or indirectly. For example, cooling by means of cold air can be used as direct cooling. However, indirect cooling of the drops by cooling the underside of the steel belt by means of cold water is preferred. Methods during which the flowable, fragrance-containing composition is cooled in step iv) are preferred in particular because of their higher product throughput.

Using the method described above, a number of different spatial shapes can be produced in varying dimensions. However, preferred fragrance-containing, dimensionally stable shaped bodies have a maximum diameter of between 4 and 15 mm, preferably between 5 and 10 mm. Corresponding shaped bodies are distinguished by advantageous usage properties, for example advantageous solution kinetics and a superior fragrance release profile.

The shaped bodies can be of any shape. The shaping is performed in particular in steps iii) and iv) of the method described. On account of their packaging properties and their performance profile, hemispherical melt bodies are particularly preferred.

100% hemispherical particles are characterized by a height to diameter ratio of 0.5. According to the invention, fragrance-containing, dimensionally stable shaped bodies which have a hemispherical shape and a height to diameter ratio of from 0.25 to 0.49, preferably from 0.35 to 0.45, are preferred.

The weight of the individual fragrance-containing, dimensionally stable shaped bodies is preferably between 2 and 150 mg, more preferably between 5 and 10 mg.

This application also relates to a fragrance-containing, dimensionally stable shaped body produced using the method described above.

The table below shows the composition of some preferred dimensionally stable, fragrance-containing shaped bodies produced using the method described above. These shaped bodies can of course also be produced using alternative methods.

| | Formula 1 | Formula 2 | Formula 3 | Formula 4 | Formula 5 |
|---|---|---|---|---|---|
| Hydrocolloid | 0.2 to 25 | 0.2 to 25 | 1.0 to 22 | 1.0 to 22 | 2.0 to 15 |
| Fragrance | 1.0 to 20 | 1.0 to 15 | 1.0 to 15 | 3.0 to 10 | 3.0 to 10 |
| Water | 10 to 95 | 10 to 95 | 10 to 95 | 15 to 90 | 15 to 90 |
| Misc. | up to 100 | up to 100 | up to 100 | up to 100 | up to 100 |
| | Formula 6 | Formula 7 | Formula 8 | Formula 9 | Formula 10 |
| Hydrocolloid | 0.2 to 25 | 0.2 to 25 | 1.0 to 22 | 1.0 to 22 | 2.0 to 15 |
| Perfume oil | 1.0 to 20 | 1.0 to 15 | 1.0 to 15 | 3.0 to 10 | 3.0 to 10 |
| Water | 10 to 95 | 10 to 95 | 10 to 95 | 15 to 90 | 15 to 90 |
| Misc. | up to 100 | up to 100 | up to 100 | up to 100 | up to 100 |
| | Formula 11 | Formula 12 | Formula 13 | Formula 14 | Formula 15 |
| Hydrocolloid | 0.2 to 25 | 0.2 to 25 | 1.0 to 22 | 1.0 to 22 | 2.0 to 15 |
| Fragrance capsules | 1.0 to 20 | 1.0 to 15 | 1.0 to 15 | 3.0 to 10 | 3.0 to 10 |
| Water | 10 to 95 | 10 to 95 | 10 to 95 | 15 to 90 | 15 to 90 |
| Misc. | up to 100 | up to 100 | up to 100 | up to 100 | up to 100 |
| | Formula 16 | Formula 17 | Formula 18 | Formula 19 | Formula 20 |
| Hydrocolloid | 0.2 to 25 | 0.2 to 25 | 1.0 to 22 | 1.0 to 22 | 2.0 to 15 |
| Perfume oil and | 1.0 to 20 | 1.0 to 15 | 1.0 to 15 | 3.0 to 10 | 3.0 to 10 |
| fragrance capsules | | | | | |
| Water | 10 to 95 | 10 to 95 | 10 to 95 | 15 to 90 | 15 to 90 |
| Misc. | up to 100 | up to 100 | up to 100 | up to 100 | up to 100 |
| | Formula 21 | Formula 22 | Formula 23 | Formula 24 | Formula 25 |
| Natural hydrocolloid | 0.2 to 25 | 0.2 to 25 | 1.0 to 22 | 1.0 to 22 | 2.0 to 15 |
| Fragrance | 1.0 to 20 | 1.0 to 15 | 1.0 to 15 | 3.0 to 10 | 3.0 to 10 |
| Water | 10 to 95 | 10 to 95 | 10 to 95 | 15 to 90 | 15 to 90 |
| Misc. | up to 100 | up to 100 | up to 100 | up to 100 | up to 100 |
| | Formula 26 | Formula 27 | Formula 28 | Formula 29 | Formula 30 |
| Natural hydrocolloid | 0.2 to 25 | 0.2 to 25 | 1.0 to 22 | 1.0 to 22 | 2.0 to 15 |
| Perfume oil | 1.0 to 20 | 1.0 to 15 | 1.0 to 15 | 3.0 to 10 | 3.0 to 10 |
| Water | 10 to 95 | 10 to 95 | 10 to 95 | 15 to 90 | 15 to 90 |
| Misc. | up to 100 | up to 100 | up to 100 | up to 100 | up to 100 |
| | Formula 31 | Formula 32 | Formula 33 | Formula 34 | Formula 35 |
| Natural hydrocolloid | 0.2 to 25 | 0.2 to 25 | 1.0 to 22 | 1.0 to 22 | 2.0 to 15 |
| Fragrance capsules | 1.0 to 20 | 1.0 to 15 | 1.0 to 15 | 3.0 to 10 | 3.0 to 10 |
| Water | 10 to 95 | 10 to 95 | 10 to 95 | 15 to 90 | 15 to 90 |
| Misc. | up to 100 | up to 100 | up to 100 | up to 100 | up to 100 |
| | Formula 36 | Formula 37 | Formula 38 | Formula 39 | Formula 40 |
| Natural hydrocolloid | 0.2 to 25 | 0.2 to 25 | 1.0 to 22 | 1.0 to 22 | 2.0 to 15 |
| Perfume oil and | 1.0 to 20 | 1.0 to 15 | 1.0 to 15 | 3.0 to 10 | 3.0 to 10 |
| fragrance capsules | | | | | |
| Water | 10 to 95 | 10 to 95 | 10 to 95 | 15 to 90 | 15 to 90 |
| Misc. | up to 100 | up to 100 | up to 100 | up to 100 | up to 100 |
| | Formula 41 | Formula 42 | Formula 43 | Formula 44 | Formula 45 |
| Hydrocolloid | 0.2 to 25 | 0.2 to 25 | 1.0 to 22 | 1.0 to 22 | 2.0 to 15 |
| Fragrance | 1.0 to 20 | 1.0 to 15 | 1.0 to 15 | 3.0 to 10 | 3.0 to 10 |
| Water-miscible | 1.0 to 30 | 2.0 to 25 | 2.0 to 25 | 2.0 to 25 | 5.0 to 20 |
| organic solvent | | | | | |
| Water | 10 to 95 | 10 to 95 | 10 to 95 | 15 to 90 | 15 to 90 |
| Misc. | up to 100 | up to 100 | up to 100 | up to 100 | up to 100 |
| | Formula 46 | Formula 47 | Formula 48 | Formula 49 | Formula 50 |
| Hydrocolloid | 0.2 to 25 | 0.2 to 25 | 1.0 to 22 | 1.0 to 22 | 2.0 to 15 |
| Perfume oil | 1.0 to 20 | 1.0 to 15 | 1.0 to 15 | 3.0 to 10 | 3.0 to 10 |
| Water-miscible | 1.0 to 30 | 2.0 to 25 | 2.0 to 25 | 2.0 to 25 | 5.0 to 20 |
| organic solvent | | | | | |
| Water | 10 to 95 | 10 to 95 | 10 to 95 | 15 to 90 | 15 to 90 |
| Misc. | up to 100 | up to 100 | up to 100 | up to 100 | up to 100 |
| | Formula 51 | Formula 52 | Formula 53 | Formula 54 | Formula 55 |
| Hydrocolloid | 0.2 to 25 | 0.2 to 25 | 1.0 to 22 | 1.0 to 22 | 2.0 to 15 |
| Fragrance capsules | 1.0 to 20 | 1.0 to 15 | 1.0 to 15 | 3.0 to 10 | 3.0 to 10 |
| Water-miscible | 1.0 to 30 | 2.0 to 25 | 2.0 to 25 | 2.0 to 25 | 5.0 to 20 |
| organic solvent | | | | | |
| Water | 10 to 95 | 10 to 95 | 10 to 95 | 15 to 90 | 15 to 90 |
| Misc. | up to 100 | up to 100 | up to 100 | up to 100 | up to 100 |
| | Formula 56 | Formula 57 | Formula 58 | Formula 59 | Formula 60 |
| Hydrocolloid | 0.2 to 25 | 0.2 to 25 | 1.0 to 22 | 1.0 to 22 | 2.0 to 15 |
| Perfume oil and | 1.0 to 20 | 1.0 to 15 | 1.0 to 15 | 3.0 to 10 | 3.0 to 10 |
| fragrance capsules | | | | | |
| Water-miscible | 1.0 to 30 | 2.0 to 25 | 2.0 to 25 | 2.0 to 25 | 5.0 to 20 |
| organic solvent | | | | | |
| Water | 10 to 95 | 10 to 95 | 10 to 95 | 15 to 90 | 15 to 90 |
| Misc. | up to 100 | up to 100 | up to 100 | up to 100 | up to 100 |
| | Formula 61 | Formula 62 | Formula 63 | Formula 64 | Formula 65 |
| Natural hydrocolloid | 0.2 to 25 | 0.2 to 25 | 1.0 to 22 | 1.0 to 22 | 2.0 to 15 |
| Fragrance | 1.0 to 20 | 1.0 to 15 | 1.0 to 15 | 3.0 to 10 | 3.0 to 10 |
| Water-miscible | 1.0 to 30 | 2.0 to 25 | 2.0 to 25 | 2.0 to 25 | 5.0 to 20 |
| organic solvent | | | | | |
| Water | 10 to 95 | 10 to 95 | 10 to 95 | 15 to 90 | 15 to 90 |
| Misc. | up to 100 | up to 100 | up to 100 | up to 100 | up to 100 |
| | Formula 66 | Formula 67 | Formula 68 | Formula 69 | Formula 70 |
| Natural hydrocolloid | 0.2 to 25 | 0.2 to 25 | 1.0 to 22 | 1.0 to 22 | 2.0 to 15 |
| Perfume oil | 1.0 to 20 | 1.0 to 15 | 1.0 to 15 | 3.0 to 10 | 3.0 to 10 |
| Water-miscible | 1.0 to 30 | 2.0 to 25 | 2.0 to 25 | 2.0 to 25 | 5.0 to 20 |
| organic solvent | | | | | |
| Water | 10 to 95 | 10 to 95 | 10 to 95 | 15 to 90 | 15 to 90 |
| Misc. | up to 100 | up to 100 | up to 100 | up to 100 | up to 100 |
| | Formula 71 | Formula 72 | Formula 73 | Formula 74 | Formula 75 |
| Natural hydrocolloid | 0.2 to 25 | 0.2 to 25 | 1.0 to 22 | 1.0 to 22 | 2.0 to 15 |
| Fragrance capsules | 1.0 to 20 | 1.0 to 15 | 1.0 to 15 | 3.0 to 10 | 3.0 to 10 |
| Water-miscible | 1.0 to 30 | 2.0 to 25 | 2.0 to 25 | 2.0 to 25 | 5.0 to 20 |
| organic solvent | | | | | |
| Water | 10 to 95 | 10 to 95 | 10 to 95 | 15 to 90 | 15 to 90 |
| Misc. | up to 100 | up to 100 | up to 100 | up to 100 | up to 100 |
| | Formula 76 | Formula 77 | Formula 78 | Formula 79 | Formula 80 |
| Natural hydrocolloid | 0.2 to 25 | 0.2 to 25 | 1.0 to 22 | 1.0 to 22 | 2.0 to 15 |
| Perfume oil and | 1.0 to 20 | 1.0 to 15 | 1.0 to 15 | 3.0 to 10 | 3.0 to 10 |
| fragrance capsules | | | | | |
| Water-miscible | 1.0 to 30 | 2.0 to 25 | 2.0 to 25 | 2.0 to 25 | 5.0 to 20 |
| organic solvent | | | | | |
| Water | 10 to 95 | 10 to 95 | 10 to 95 | 15 to 90 | 15 to 90 |
| Misc. | up to 100 | up to 100 | up to 100 | up to 100 | up to 100 |
| | Formula 81 | Formula 82 | Formula 83 | Formula 84 | Formula 85 |
| Natural hydrocolloid | 0.2 to 25 | 0.2 to 25 | 1.0 to 22 | 1.0 to 22 | 2.0 to 15 |
| Perfume oil and | 1.0 to 20 | 1.0 to 15 | 1.0 to 15 | 3.0 to 10 | 3.0 to 10 |
| fragrance capsules | | | | | |
| Disintegration | 0.05 to 5.0 | 0.1 to 3.0 | 0.1 to 3.0 | 0.2 to 2.0 | 0.2 to 2.0 |
| auxiliary | | | | | |
| Water-miscible | 1.0 to 30 | 2.0 to 25 | 2.0 to 25 | 2.0 to 25 | 5.0 to 20 |
| organic solvent | | | | | |
| Water | 10 to 95 | 10 to 95 | 10 to 95 | 15 to 90 | 15 to 90 |
| Misc. | up to 100 | up to 100 | up to 100 | up to 100 | up to 100 |

As mentioned at the outset, the fragrance-containing shaped bodies are particularly suitable for fragrancing textiles. Another subject matter being claimed is therefore the use of these fragrance-containing, dimensionally stable shaped bodies as textile care products, preferably fragrancing agents and/or softeners, for fragrancing and/or conditioning textile fabrics. It is particularly preferable to use the fragrance-containing, dimensionally stable shaped bodies as fragrancing agents for fragrancing textile fabrics.

The dimensionally stable, fragrance-containing shaped bodies described above can be used as independent textile care agents or in combination with at least one further textile care agent. The combined use of the dimensionally stable, fragrance-containing shaped bodies with a washing or cleaning agent is particularly preferred. This application therefore also relates to a washing or cleaning agent comprising the fragrance-containing, dimensionally stable shaped bodies described above.

In summary, the present invention provides, inter alia:
1. A method for producing dimensionally stable, fragrance-containing shaped bodies for textile care, comprising the following steps:
   i) producing a flowable preparation comprising water and at least one hydrocolloid;
   ii) mixing the preparation from step i) with at least one fragrance so as to form a flowable, fragrance-containing preparation;
   iii) portioning the flowable, fragrance-containing preparation from step ii);
   iv) forming dimensionally stable, fragrance-containing shaped bodies.
2. The method according to point 1, characterized in that the flowable preparation in step i) has a temperature of between 40 and 100° C.
3. The method according to one of the preceding points, characterized in that the flowable preparation in step i) has a viscosity (50° C., Kinexus Ultra+, 2 cm plate and 800 μm column, shear rate 1/s) of from 10 to 800 Pas, preferably from 20 to 600 Pas.
4. The method according to one of the preceding points, characterized in that the hydrocolloid is selected from the group of synthetic hydrocolloids, preferably from the group of polyacrylic polymers and polymethacrylic polymers, particularly preferably from the group of crosslinked polyacrylic acid polymers.
5. The method according to one of the preceding points, characterized in that the hydrocolloid is selected from the group of natural hydrocolloids, preferably from the group of gelatin, agar, gum arabic, guar gum, gellan gum, alginates, carrageenan carraghenates and pectins, particularly preferably from the group of gelatin and agar.
6. The method according to one of the preceding points, characterized in that the proportion by weight of water with respect to the total weight of the dimensionally stable, fragrance-containing shaped body is from 10 to 95 wt. %, preferably from 15 to 90 wt. %, and in particular from 15 to 75 wt. %.
7. The method according to one of the preceding points, characterized in that the proportion by weight of the hydrocolloid with respect to the total weight of the dimensionally stable, fragrance-containing shaped body is from 0.2 to 25 wt. %, preferably from 1.0 to 22 wt. %, and in particular from 2.0 to 15 wt. %.
8. The method according to one of the preceding points, characterized in that the fragrance in step ii) is selected from the group of perfume oils and fragrance capsules.
9. The method according to one of the preceding points, characterized in that the proportion by weight of the fragrance with respect to the total weight of the dimensionally stable, fragrance-containing shaped body is from 1 to 20 wt. %, preferably from 1 to 15 wt. %, and in particular from 3 to 10 wt. %.
10. The method according to one of the preceding points, characterized in that at least one water-miscible organic solvent, preferably at least one solvent from the group of ethanol, n-propanol, i-propanol, butanols, glycol, propanediol, butanediol, methylpropanediol, glycerol, propylene carbonate, diglycol, propyl diglycol, butyl diglycol, hexylene glycol, diethylene glycol ethyl ether, diethylene glycol methyl ether, diethylene glycol-n-butyl ether, diethylene glycol hexyl ether, diethylene glycol-n-butyl ether acetate, ethylene glycol propyl ether, ethylene glycol-n-butyl ether, ethylene glycol hexyl ether, ethylene glycol-n-butyl ether acetate, triethylene glycol, triethylene glycol methyl ether, triethylene glycol ethyl ether, triethylene glycol-n-butyl ether, ethylene glycol phenyl ether, propylene glycol methyl ether, dipropylene glycol methyl ether, tripropylene glycol methyl ether, propylene glycol methyl ether acetate, dipropylene glycol methyl ether acetate, propylene glycol-n-propyl ether, dipropylene glycol-n-propyl ether, propylene glycol-n-butyl ether, dipropylene glycol-n-butyl ether, tripropylene glycol-n-butyl ether, propylene glycol phenyl ether, propylene glycol diacetate, dipropylene glycol dimethyl ether, methoxytriglycol, ethoxytriglycol, butoxytriglycol, 1-butoxyethoxy-2-propanol, 3-methyl-3-methoxybutanol, propylene-glycol-t-butyl ether and di-n-octylether, more preferably from the group of glycerol, propylene glycol and triethylene glycol, in particular glycerol, is also added to the flowable, fragrance-containing preparation before step iii).
11. The method according to point 10, characterized in that the proportion by weight of the water-miscible organic solvent with respect to the total weight of the dimensionally stable, fragrance-containing shaped body is from 1.0 to 30 wt. %, preferably from 2.0 to 25 wt. %, and in particular from 10 to 20 wt. %.
12. The method according to one of the preceding points, characterized in that at least one rheology modifier from the group of microfibrillated or microcrystalline celluloses is also added to the flowable, fragrance-containing composition before step iii).
13. The method according to point 12, characterized in that the proportion by weight of the rheology modifier with respect to the total weight of the dimensionally stable, fragrance-containing shaped body is from 0.5 to 20 wt. %, preferably from 1.0 to 18 wt. %, and in particular from 2.0 to 15 wt. %.
14. The method according to one of the preceding points, characterized in that at least one disintegration auxiliary that is different from the hydrocolloid and comes from the group of synthetic polymers, preferably from the group of polyacrylates and polyvinylpyrrolidones, in particular crosslinked polyvinylpyrrolidones, is also added to the flowable, fragrance-containing composition before step iii).
15. The method according to point 14, characterized in that the proportion by weight of the disintegration auxiliary with respect to the total weight of the dimensionally stable, fragrance-containing shaped body is from 0.05 to 5 wt. %, preferably from 0.1 to 3 wt. %, and in particular from 0.2 to 2 wt. %.
16. The method according to one of the preceding points, characterized in that at least one non-ionic surfactant, preferably a non-ionic surfactant from the group of polyalkoxylated sorbitan acid esters, is also added to the flowable, fragrance-containing composition before step iii).
17. The method according to point 16, characterized in that the proportion by weight of the non-ionic surfactant with respect to the total weight of the dimensionally stable, fragrance-containing shaped body is from 0.05 to 3.0 wt. %, preferably from 0.1 to 2.0 wt. %.
18. The method according to one of the preceding points, characterized in that at least one solid from the group consisting of polysaccharides, silicic acids, silicates, sulfates, phosphates, halides and carbonates is also added to the flowable, fragrance-containing composition before step iii).
19. The method according to one of the preceding points, characterized in that at least one dye, preferably at least one water-soluble dye, particularly preferably a water-soluble polymer dye, is also added to the flowable, fragrance-containing composition before step iii).
20. The method according to one of the preceding points, characterized in that at least one preservative is also added to the flowable, fragrance-containing composition before step iii).
21. The method according to one of the preceding points, characterized in that at least one bittern is also added to the flowable, fragrance-containing composition before step iii).
22. The method according to one of the preceding points, characterized in that the flowable, fragrance-containing composition is portioned in step iii) by being applied to a surface in a dropwise manner.
23. The method according to one of the preceding points, characterized in that the flowable, fragrance-containing composition is portioned in step iii) by being applied to a steel belt in a dropwise manner by means of a drop former comprising a rotating, perforated outer drum.
24. The method according to one of the preceding points, characterized in that the flowable, fragrance-containing composition is cooled in step iv).
25. The method according to one of the preceding points, characterized in that the fragrance-containing, dimensionally stable shaped body has a maximum diameter of between 4 and 15 mm, preferably between 5 and 10 mm.
26. The method according to one of the preceding points, characterized in that the fragrance-containing, dimensionally stable shaped body has a hemispherical shape and has a height to diameter ratio of from 0.25 to 0.49, preferably from 0.35 to 0.45.
27. The method according to one of the preceding points, characterized in that the fragrance-containing, dimensionally stable shaped body has a weight of from 2 to 150 mg, preferably from 5 to 10 mg.
28. A fragrance-containing, dimensionally stable shaped body produced using a method according to one of the preceding points.
29. The use of fragrance-containing, dimensionally stable shaped bodies according to point 28 as textile care agents, preferably fragrancing agents and/or softeners, for fragrancing and/or conditioning textile fabrics.
30. A washing or cleaning agent comprising a fragrance-containing, dimensionally stable shaped body according to point 28.

### Example 1

| | Wt. % |
|---|---|
| Agar-agar | 1.5 |
| Polyvinyl pyrrolidone, cross-linked | 0.6 |
| Microcrystalline cellulose | 12.5 |
| Sodium acetate trihydrate | 1.5 |
| Glycerol | 20 |
| Fragrance capsules | 1.4 |
| Fragrance | 6.0 |
| Water | up to 100 |

At 100° C., agar-agar and sodium acetate are dissolved in water and glycerol. After the agar-agar has dissolved completely, the solution is cooled to 70° C. and the remaining constituents are added. The resulting flowable, fragrance-containing preparation is cooled to 55° C. and then applied to a cold surface (10° C.) in a dropwise manner. Dimensionally stable, fragrance-containing shaped bodies are formed, which are cooled completely after five minutes.

### Example 2

| | Wt. % |
|---|---|
| Agar-agar | 1.8 |
| Polyvinyl pyrrolidone, cross-linked | 0.3 |
| Sucrose | 50 |
| Citric acid | 7.5 |
| Sorbitan monooleate 20EO | 1.0 |
| Glycerol | 18 |
| Fragrance capsules | 5.0 |
| Fragrance | 5.0 |
| Water | up to 100 |

At 100° C., agar-agar, citric acid and sucrose are dissolved in water and glycerol. After the agar-agar has dissolved completely, the solution is cooled to 70° C. and the remaining constituents are added. The resulting flowable, fragrance-containing preparation is cooled to 55° C. and then applied to a cold surface (10° C.) in a dropwise manner. Dimensionally stable, fragrance-containing shaped bodies are formed, which are cooled completely after five minutes.

### Example 3

| | Wt. % |
|---|---|
| Gelatin | 1.8 |
| Glycerol | 10 |
| Fragrance capsules | 5.0 |
| Fragrance | 5.0 |
| Water | up to 100 |

At 100° C., the gelatin is dissolved in water and glycerol. After the agar-agar has dissolved completely, the solution is cooled to 70° C. and the remaining constituents are added. The resulting flowable, fragrance-containing preparation is cooled to 55° C. and then applied to a cold surface (10° C.) in a dropwise manner. Dimensionally stable, fragrance-containing shaped bodies are formed, which are cooled completely after five minutes.

What is claimed is:

1. A method for producing dimensionally stable, fragrance-containing shaped bodies for textile care, comprising the following steps:
i) producing a flowable preparation comprising water and at least one hydrocolloid;
ii) mixing the preparation from step i) with at least one fragrance so as to form a flowable, fragrance-containing preparation;
iii) portioning the flowable, fragrance-containing preparation from step ii);
iv) forming dimensionally stable, fragrance-containing shaped bodies.

2. The method according to claim 1, characterized in that the flowable preparation in step i) has a temperature of between 40 and 100° C.

3. The method according to claim 1, wherein the flowable preparation in step i) has a viscosity (50° C., Kinexus Ultra+, 2 cm plate and 800 μm column, shear rate 1/s) from 10 to 800 Pas.

4. The method according to claim 1, wherein the hydrocolloid is selected from the group of natural hydrocolloids.

5. The method according to claim 1, wherein the proportion by weight of water with respect to the total weight of the dimensionally stable, fragrance-containing shaped body is from 10 to 95 wt. %.

6. The method according to claim 1, wherein the proportion by weight of the natural hydrocolloid with respect to the total weight of the dimensionally stable, fragrance-containing shaped body is from 0.2 to 25 wt. %.

7. The method according to claim 1, wherein the fragrance in step ii) is selected from the group of perfume oils and fragrance capsules.

8. The method according to claim 1, wherein the proportion by weight of the fragrance with respect to the total weight of the dimensionally stable, fragrance-containing shaped body is from 1 to 20 wt. %.

9. A fragrance-containing, dimensionally stable shaped body produced using a method according to claim 1.

10. The method of using fragrance-containing, dimensionally stable shaped bodies according to claim 9 as textile care agents for fragrancing and/or conditioning textile fabrics.

11. The method according to claim 3, wherein the flowable preparation in step i) has a viscosity (50° C., Kinexus Ultra+, 2 cm plate and 800 μm column, shear rate 1/s) from 20 to 600 Pas.

12. The method according to claim 4, wherein the hydrocolloid is selected from the group of gelatin, agar, gum arabic, guar gum, gellan gum, alginates, carrageenan carraghenates and pectins.

13. The method according to claim 4, wherein the hydrocolloid is selected from the group of gelatin and agar.

14. The method according to claim 5, wherein the proportion by weight of water with respect to the total weight of the dimensionally stable, fragrance-containing shaped body is from 15 to 90 wt. %.

15. The method according to claim 5, wherein the proportion by weight of water with respect to the total weight of the dimensionally stable, fragrance-containing shaped body is from 15 to 75 wt. %.

16. The method according to claim 6, wherein the proportion by weight of the natural hydrocolloid with respect to the total weight of the dimensionally stable, fragrance-containing shaped body is from 1.0 to 22 wt. %.

17. The method according to claim 8, wherein the proportion by weight of the fragrance with respect to the total weight of the dimensionally stable, fragrance-containing shaped body is from 1 to 15 wt. %.

18. The method according to claim 8, wherein the proportion by weight of the fragrance with respect to the total weight of the dimensionally stable, fragrance-containing shaped body is from 3 to 10 wt. %.

19. The method of using fragrance-containing, dimensionally stable shaped bodies according to claim 10, as fragrancing agents and/or softeners.
